(19) United States
(12) Patent Application Publication
(10) Pub. No.: US 2008/0133396 A1
(43) Pub. Date: Jun. 5, 2008

(54) SYSTEM AND METHOD FOR EXECUTING SECURE EXCHANGE TRANSACTIONS

(76) Inventor: Alain L. De La Motte, Hillsboro, OR (US)

Correspondence Address: KOLISCH HARTWELL, P.C., 520 SW YAMHILL STREET, Suite 200, PORTLAND, OR, 97204, US

(21) Appl. No.: 11/832,645

(22) Filed: Aug. 1, 2007

Related U.S. Application Data
(60) Provisional application No. 60/835,009, filed on Aug. 1, 2006.

(51) Int. Cl. G06Q 40/00

(52) U.S. Cl. 705/37; 705/39

(57) ABSTRACT

Embodiments of methods and/or systems for executing a secure exchange transaction are disclosed.

### CROSS-REFERENCE TO RELATED APPLICATIONS

This application claims priority to U.S. Provisional Patent Application Ser. No. 60/835,009, entitled “Clearing and Settlement for Securities Transactions,” filed on Aug. 1, 2006.

### BACKGROUND

This disclosure relates to the field of secure financial transactions, as in the case of one asset or set of assets being exchanged for another asset or set of assets in a transaction.

In a variety of circumstances, it is common to exchange one set of assets for another, as in a sale, as a simple example. In a transaction such as the purchase of real estate, as a common illustration, money may be exchanged for title to the property. Usually the parties to such a real estate transaction did not know each other before, in which case there are several potential “risk issues” in the transaction. One potential issue is the delivery of clear title and another potential issue is the delivery of the consideration or funds, and both in the context of agreed upon time. Because of these risk issues in real estate transactions, it is common to employ an escrow or escrow agent that serves as a fiduciary and intermediary. While an escrow may work in a simple transaction like the sale of real estate, it is often not suitable for more complex transactions, such as ones involving multiple financial institutions, multiple buyers and sellers, and multiple securities, securities in today's market which are often derivatives. Furthermore, even with an escrow, again, as simply an example, some risk still exists that one party may back out of the transaction and forgo the return of a security deposit provided in escrow. Therefore, there is a growing need for ways to accomplish complex exchange transactions while also potentially reducing risk to one or more of the parties.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description, if read with the accompanying drawings, in which:

FIG. 1 is a schematic diagram illustrating one embodiment of a method of executing a secure exchange transaction.

FIG. 2 is a schematic diagram illustrating another embodiment of a method of executing a secure exchange transaction.

FIG. 3 is a schematic diagram illustrating an embodiment of a set of trusts that may, for example, employ an embodiment of a method of executing a secure transaction.

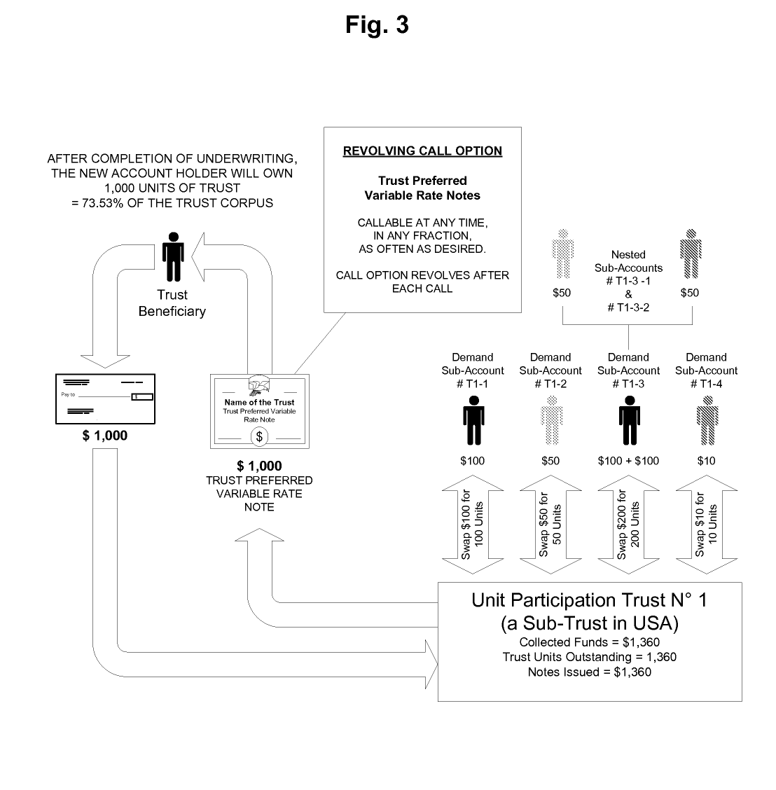

FIG. 4 is a schematic diagram illustrating another embodiment of a set of trusts that may, for example, also employ an embodiment of a method of executing a secure transaction.

FIG. 5 is a schematic diagram illustrating yet another embodiment of a set of trusts that may, for example, employ an embodiment of a method of executing a secure transaction.

FIG. 6 is a schematic diagram illustrating an embodiment of a method of aggregating assets at various trust and sub-trust levels in a set of trusts; this embodiment of a set of trusts again may, for example, employ an embodiment of a method of executing a secure transaction.

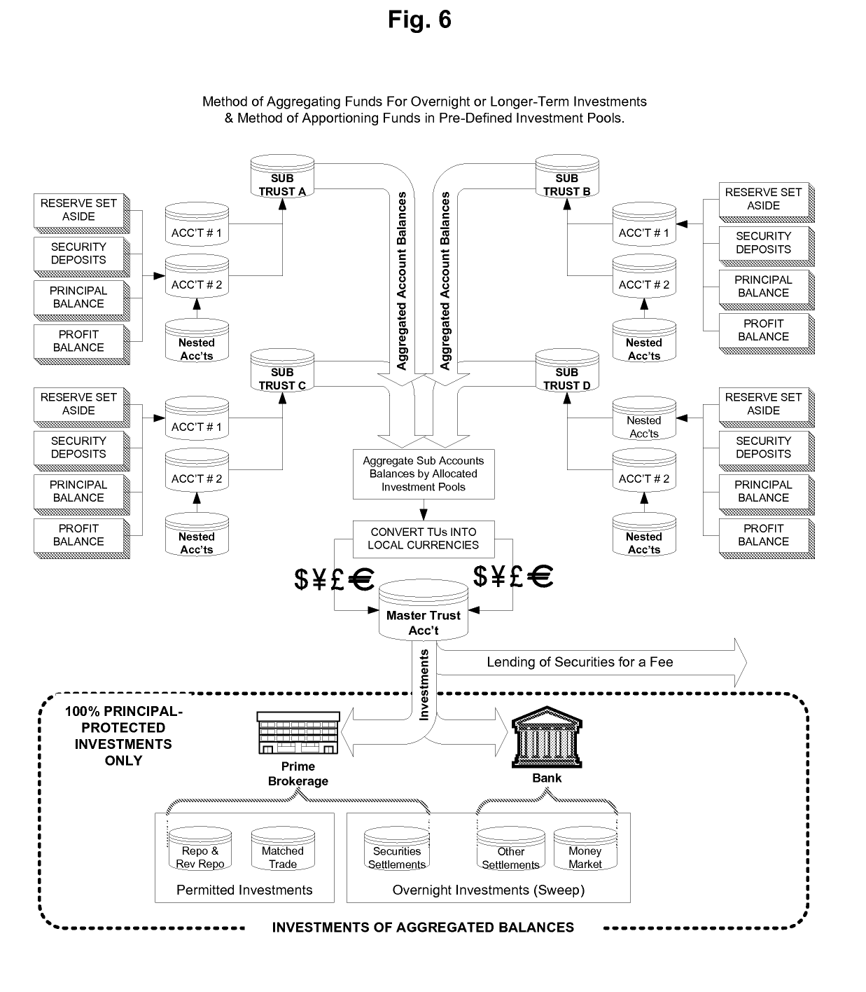

FIG. 7 is a schematic diagram illustrating an embodiment of a method of redistribution of assets and profits from a master trust to sub-trusts in a set of trusts; this embodiment of a set of trusts again may, for example, employ an embodiment of a method of executing a secure transaction.

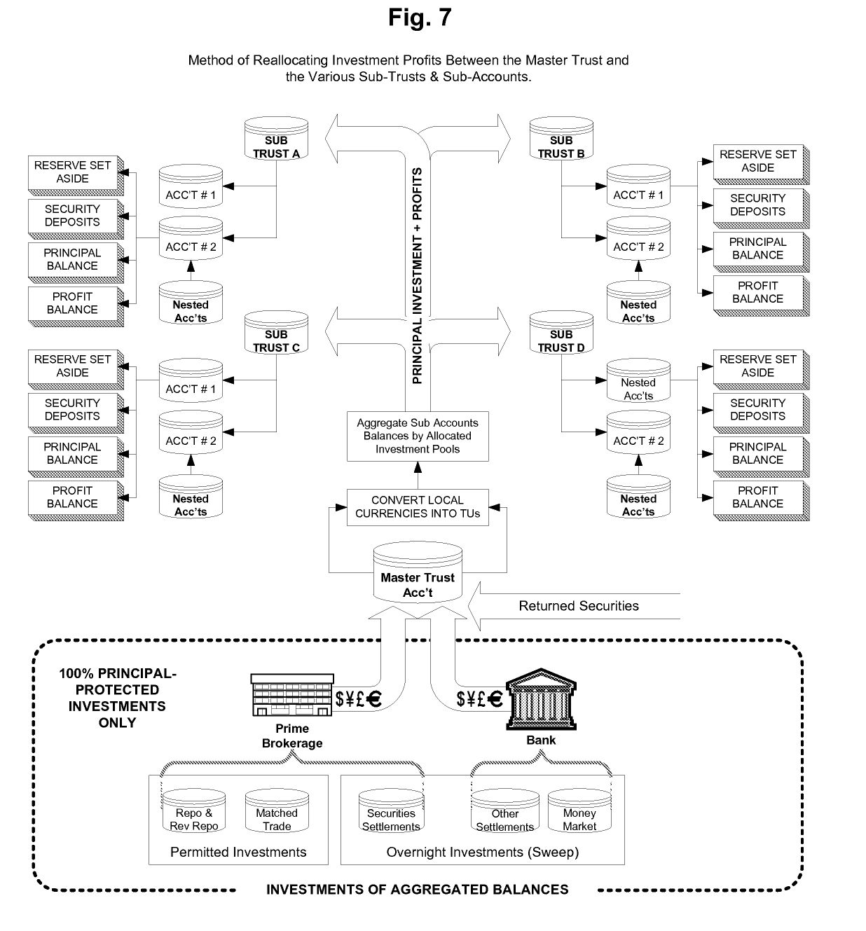

FIG. 8 is a schematic diagram illustrating an embodiment of a method of created a multi-layered structure of trusts around the world; this embodiment of a set of trusts again may, for example, employ an embodiment of a method of executing a secure transaction.

FIG. 9 is a schematic diagram illustrating an embodiment of a method of connecting local master trusts to a global computerized processing infrastructure that may link sub-trusts that exist around the world in a global platform; this embodiment of a set of trusts again may, for example, employ an embodiment of a method of executing a secure transaction.

Attachment A is a copy of U.S. Provisional Patent Application Ser. No. 60/835,009 and entitled “Clearing and Settlement for Securities Transactions”.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures and/or other aspects have not been described in detail so as not to obscure claimed subject matter.

Reference throughout this specification to “one embodiment” or “an embodiment” may mean that a particular feature, structure, or characteristic described in connection with a particular embodiment may be included in at least one embodiment of claimed subject matter. Thus, appearances of the phrase “in one embodiment” and/or “an embodiment” in various places throughout this specification are not necessarily intended to refer to the same embodiment or to any one particular embodiment described. Furthermore, it is to be understood that particular features, structures, and/or characteristics described may be combined in various ways in one or more embodiments. In general, of course, these and other issues may vary with the particular context. Therefore, the particular context of the description and the usage of these terms may provide helpful guidance regarding inferences to be drawn for that particular context.

Likewise, the terms, “and,” “or,” and “and/or” as used herein may include a variety of meanings that will depend at least in part upon the context in which it is used. Typically, “and/or” if used to associate a list, such as A, B and/or C, is intended to mean A, B, or C as well as A, B and C. Though, it should be noted that this is merely an illustrative example and claimed subject matter is not limited to this example.

Unless specifically stated otherwise, throughout this specification, terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “storing,” “authenticating,” “authorizing,” “hosting,” “determining” and/or the like refer to actions and/or processes that may be performed by a system, such as a computer and/or other computing platform, capable of manipulating and/or transforming data which may be represented as electronic, magnetic and/or other physical quantities within the system's processors, memories, registers, and/or other information storage, transmission, reception and/or display devices. Accordingly, a computing platform refers to a system or a device that includes the ability to process and/or store data in the form of signals or electronic data. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

It is noted that in the material that follows, examples of exchange transaction or transactions are provided to be illustrative, without being limiting in scope. Therefore, it should be understood that these examples are not meant to be exclusive or limiting in any way with respect to claimed subject matter. Rather, claimed subject matter is not limited in scope to these particular example transactions.

As stated previously, it is desirable to have an approach or method for executing exchange transactions in which risks, such as those associated with one of the parties to the transaction not performing, after the other party to the transaction has performed, are significantly reduced. Likewise, it is desirable for such an approach or method to make possible the effective closure of such complex transactions. Other benefits and advantages depending upon the particular embodiment will become evident from the following description. In this particular context, the notion of executing a “secure” exchange transaction is intended to refer to the notions that the parties to the transaction may remain anonymous, if desired, while the risk of a failed transaction is reduced to such an extent that it is highly likely that the transaction will successfully close.

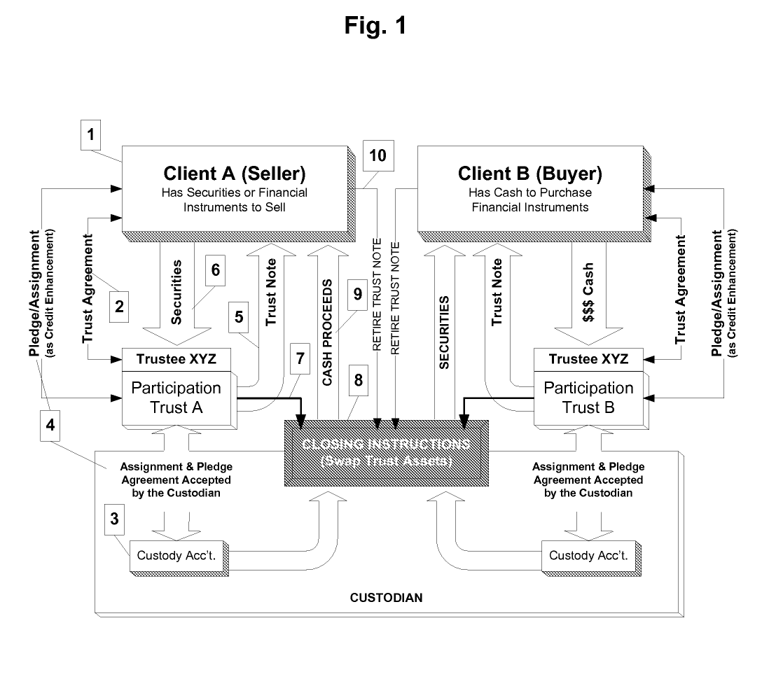

FIG. 1 is a schematic diagram of one embodiment, here embodiment 100, of a method of executing a secure transaction. This embodiment is described in greater detail below. However, again, we intend this embodiment as merely an example of one type of transaction, in this example, an exchange of funds or cash for securities. Nonetheless, a virtually unlimited variety of exchange transactions may be executed and remain within the scope of claimed subject matter. Therefore, many other types of asset exchanges are intended to be covered regardless of whether the transaction involves cash or securities. Rather, this particular transaction is both illustrative while addressing a relatively common transaction that may benefit from employing claimed subject matter of this patent application.

More specifically, the purchase and sale of securities is a highly regulated and controlled sector of the financial industry throughout the world. At least in part because the issuance of a security may involve the exchange of equities or debt instruments for cash, the risk of non-payment and/or failed delivery of an instrument may exist for both buyer and seller, even if the principal assets of both parties are protected through a mechanism adopted to close.

Failed transactions are believed to represent a substantial percentage of all closed securities transactions worldwide. Failed cross-border transactions may have an even greater risk and percentage of failure. A reason that contributes to this is the added risk of compliance for the assets involved in the trade, the parties themselves and the origin of their cash (to comply with money laundering laws and regulations).

In the case of a traditional sale or purchase of a security, seller and buyers usually contact their respective brokers who are then given the charge to close the sale or purchase of a security. Brokers and bankers typically receive brokerage and bank fees for such services.

As is known, the securities industry already offers various ways of settling a transaction. This includes such electronic clearing and settlement methods as those offered by such organizations as DTC, Euroclear, and SWIFT, which are systems that link brokers and banks into a web-like network that provides an electronic communications interface to allow the parties to consummate a transaction with reduced risk and in a reduced amount of time compared with non-electronic approaches, for example.

Various closing terms and methods have been designed to reduce the risk of non-payment or non-delivery of securities once a trade is consummated. To alleviate this problem, common methods have been implemented through electronic processes that allow either the buyer or seller of a security to deliver (e.g., cash or security) first based on the type of transaction and agreed terms between buyer and seller. A common transaction in which first the tender of cash occurs is referred to here as a Payment Versus Delivery (PVD). More commonly this may also be referred to as a funds-first transaction. This form of payment is more often used in so-called “fresh” issue underwriting where the tendering of the agreed purchase price of a new issue will trigger the legal issuance and delivery of a new security (or of new securities) to the buyer or his underwriting agent. A transaction involving the sale of securities that are already “seasoned” (e.g., the instruments already exist and is in circulation) may be referred to as “Deliver Versus Payment” (DVP) which simply means here that the securities are delivered first and cash follows after the securities have been verified and authenticated by the buyer or his broker or agent.

However, none of these methods address the issue of theft or derailment of a transaction by unethical brokers, bankers or intermediaries. There may also be added risk present in traditional closing processes. This may exist, for example, for those transactions where the security does not have an efficient market that determines up-to-the-second pricing. Examples, without limitation, of this include a security that is part of a new issue underwriting, or a security that is part of a non-registered private placement between two “accredited investors.” Once intermediaries (e.g. securities brokers, bank employees) become aware of the identity of buyers and sellers in a trade and realize the potential size of the spread between the buying and selling price, there is always the risk that a broker or banker in-the-know might use another source of cash or security to derail the initial deal by arranging (perhaps even by subterfuge) to up the anti, so to speak. Due at least in part to the complexity of these potential situations and the variety of types of transactions, there are potentially dozens of situations, or more, that make it possible for unethical intermediaries to derail or otherwise interfere with an already agreed upon transaction once they are made aware of the details. Furthermore, depending on the specifics, this may be accomplished without substantial risk to the intermediary, who may then profit directly or indirectly from the diverted transaction. This sort of problem potentially occurs daily and at least in part explains why there are securities regulatory agencies around the world busy protecting unsuspecting trading parties.

Although claimed subject matter is not limited in scope to any particular embodiment, it is noted that at least several of the approaches described herein, for example, provide a method of reducing such potential risks associated with the trade itself or the disclosure of the identity of buyers and sellers. Therefore, at least some of the implementation approaches provided address risks, such as the risks of non-payment, the risk of failed delivery of a security, and/or the risk of derailment or interference with a profitable and agreed upon trade.

A number of possible implementations are intended to be included within the scope of claimed subject matter—implementations that are discussed as well as implementations that, while not discussed, follow from the subject matter that is discussed. One aspect of a potential implementation that may be employed in at least some implementations, although is not necessarily required, depending on the transaction details, relates to securities lending practices, a very profitable area of business for brokerage houses and securities firms throughout the world. For example, if a securities brokerage firm offers to close a trade for as little as $7 per trade the securities firms may additionally make substantial profits through the lending of the stocks on deposit in their client's accounts. Therefore, profit comes both from collecting a fee to orchestrate the trade and from lending the securities to others for other unrelated transactions.

To illustrate that latter point, consider the example of a trade in which the holder of a brokerage account (e.g., an investor) gives an order to his broker to buy 100 shares of IBM. The client is long on IBM which, in general, indicates that the investor should expect the price of the stock to increase over time. The investor, therefore, is investing in IBM stocks today in the hope of reselling it at a future date at a higher price.

In this case, the customer's cash account is credited (decreased) for the value of the trade and the securities account is debited (increased) with 100 shares of IBM valued at the executed trading price of $100 a share (a $10,000 investment). Let's assume further that the account holder requested (by checking the box on the account opening form) to have a margin account. This simply means that, in the United States, for example, the buyer of a marginable security will be able to buy individual stocks worth $100 by providing $50 of his funds since the margin account permits him to borrow up to 50% of the contemplated purchase price of a marginable stock, giving him a trading leverage of 2:1. In other words, in this latter situation, the investor is borrowing $5,000 while providing $5,000 to settle the $10,000 transaction trade.

If the IBM share price increases to say $120, he can earn a $2,000 profit on a cash investment of $5,000 by reselling it at the increased price. However, if the price falls, because he borrowed funds at the maximum amount of leverage, 2:1, he may have to provide additional funds from elsewhere to satisfy a margin call or else the brokerage may have to sell the securities to make up the difference. For example, if the price of the stock falls to $75, the brokerage faces some risk of non-payment from the decrease in the value of the assets. Therefore, the investor needs to provide another $2500 or the brokerage needs to sell $2500 worth of the stock at the $75 share price to create enough cash to keep the leverage at the regulatory maximum of 2:1.

Since stock markets are driven by buyers and sellers who have different trading objectives—some go “long” and some go “short”, the interaction of supply and demand helps create an efficient market that allows stock prices to rise or fall based on the market.

In a long transaction, the buyer buys a security which he resells at a higher price at a future date. In a short transaction, the process is reversed, namely the short “seller” sells a borrowed instrument today at today's market price and buys it back later at a lower price so that he can return the borrowed stock to the lender.

Borrowing of securities is normally done by borrowing from the stock pool of depositories for a particular security, commonly referred to as the “street” pool. If such borrowing takes place, typically the lender collects substantial commissions and fees for stocks that are on deposit in their “long” clients' portfolio accounts.

Having sold a borrowed instrument in order to accomplish a transaction in which the stock or security is “shorted,” the seller is now obligated to return that instrument at some future date. If the price of the borrowed security falls, the seller can buy it back at the lower price and resell it at the lower price thereby pocketing a profit. Likewise, if the stock is repurchased later, the stock can be returned to the depository institution that previously lent it to the short seller. Thus, securities depository institutions and brokerage firms make profits on the lending of stocks to short sellers and others who, amongst other things, may use borrowed stocks to enhance balance sheets, securitize loans, etc.

Some might take the view that such lending practices have the potential or risk of a conflict of interest. For example, making such securities available for short transactions is inconsistent with the goal of the investor to have the stock or security increase in price; however, regardless, the point being made is that profits generated from these securities lending practices are profits that could be available to the investor if a different transaction structure were to be employed, as described in more detail below.

Therefore, instead, at least some of the embodiments described herein allows buyers and sellers of securities to control their stock portfolio so that securities lending to facilitate short selling will benefit the owners of such securities directly, if they choose to allow their own stocks to be lent for profit. For example, as described in more detail below, within the context of a trust or trust-like structure in which a security holder may own units of the trust representing fractional beneficial interest units of the total trust corpus, as described in more detail later.

Thus, as one possible example, if enough securities of a particular issue are brought under the control of a trust such as that described in accordance with one or more of the embodiments described herein and the trust is managed in accordance with the terms and conditions of a trust or trust-like agreement by a fiduciary or trustee, the practices of stock lending may be employed to directly benefit the owners of securities, thereby increasing income and profits, decreasing risk, and allowing market forces to correctly account for the practice of short selling of a stock or security.

For this example, continuing with reference to FIG. 1, we assume that a Client A, termed Seller here, has securities or financial instruments to be sold. Therefore, we assume, again, without limitation, that Client A has 1000 shares of IBM common stock to be sold. Likewise, for this example, we assume that Client B, termed Buyer here, has funds, here in the form of cash, to purchase the financial instruments, or in this particular example, IBM common stock.

In a conventional approach, Seller A would provide the instruments or stock to a broker who may hold them in the “street name” or “street” pool, as explained in some detail above. The broker receiving the stock would create an account for the Seller; however, the Seller would necessarily lose possession and control of the stock certificates for at least a period time. Eventually, payment would be made to the Seller after the instruments are verified and authenticated by an Institution representing the Buyer. Therefore, the Seller, having parted with his stock, remains subject to the risk that the transaction or exchange may not be consummated, as previously discussed.

However, in embodiment 100, as an alternative to the previously described conventional approach, before any stock or any funds are delivered or deposited, two trusts or two trust-like entities are established. It is noted that in this context, the terms “trust,” “trust-like entity,” and “entity” will be used interchangeably through out this description. These terms are all intended to refer to a particular type of legal entity commonly employed in various countries of the world, and particularly in the United States, known as a “trust,” as well as entities that have sufficient features or aspects similar to that of a trust so that the entity may be referred to as “trust-like,” even if the entity may technically or legally not fully qualify as a trust per se. Of course, claimed subject matter is also not limited in scope to the number of trust or trust-like entities, depending on a particular transaction. In this particular embodiment, the two trusts or trust-like entities are virtually identical in legal form, substance, and structure (through the execution or adoption of substantially similar trust agreements), except that one holds the IBM stock and the other holds the funds to purchase the stock at the agreed upon price.

In FIG. 1, for simplicity, we refer to the trust or trust-like entity to hold the stock as Trust A and the trust or trust-like entity to hold the funds as Trust B, although, as previously indicated, in some embodiments these entities may not technically or legally fully qualify as trusts per se. Therefore, Client A, referred to in FIG. 1 as 1, may execute a trust agreement or trust-like agreement with a fiduciary trustee or other trust-like fiduciary to establish Trust A. This is designated in FIG. 1 as 2. It is further noted, as described in more detail below, that Trust A may issue promissory notes or trust notes to Client A to reflect the value of the securities being deposited with Trust A. It is noted that through out this description the terms promissory notes and trust notes are used interchangeably and are both intended to refer to notes issued by a trust or trust-like entity. Therefore, in this particular example transaction, the owners of the respective trusts or the trust-like entities are the holders of the promissory or trust notes. It is noted, of course, that this situation may also be generalized to cover a variety of other situations, such as where there are multiple Clients and multiple holders of the notes, for example. In such a situation, for example, and without intending to limit the scope of claimed subject matter, ownership may be allocated pro-rata based upon the value of the issued notes and such value can be recognized through the allocation of trust units wherein one unit of ownership of the trust corresponds, for example, to one unit of a particular currency. As described in more detail below, in an embodiment, this type of trust or trust-like entity may be referred to as a unit participation trust, in which one unit or note is exchanged for a unit of the currency of that jurisdiction (such as US Dollars, British Pounds Sterling, European Euros, and so forth). Although, again, claimed subject matter is not limited in scope to these particular aspects, of course.

One potential advantage from the description of this particular embodiment, for example, is that Client A and Client B may have reduced their overall risk by retaining promissory or trust notes reflecting the value of the assets held for them by the respective trusts or trust-like entities. Although they may have or will relinquish their assets to the entities, they may receive in exchange another asset, namely the promissory or trust notes. In the case of the IBM stock, for example, if one were to pledge the stock as security in a conventional transaction, one should usually obtain credit up to 50% of the fair market value of the stock, if buying on margin, as previously described, for example. However, the promissory or trust notes, if issued by a trust, for example, with security backing them, may be qualified as a highly rated security. Therefore, if such promissory or trust notes were pledged as security in a conventional transaction, not only would the credit risk be highly rated, but the trust instrument can be viewed as a highly liquid instrument which, for example, under the New York Federal Reserve Bank's (the central bank) “Borrower in Custody” program for trust-preferred securities may qualify for a margin as high as 92% to 94% of fair market value.

Continuing with the description of this particular embodiment, in addition, a pledge/assignment agreement, designated as 3 in FIG. 1, may also be executed as part of the creation of the entity. In this way, a Client who provides assets to a trust or trust-like entity may obtain additional protection in that the pledge/assignment agreement may be written in such as way so as to give the Client a first lien on the assets on deposit in the entity. Thus, in addition to a trust agreement or similar agreement creating a trust-like entity, the trustee or similar fiduciary and Client A, for example, may execute an assignment of the securities account between them. The agreement may be prepared, in one embodiment, for example, to create a first security interest in the entity's assets on deposit in a custody account set up by the entity. Under this agreement, for example, in one embodiment, the entity may be the debtor to Client A and the agreement may provide that Client A may automatically be appointed as the de facto trustee or other fiduciary of the entity if certain prescribed and well-defined events occur. Thus, Client A obtains an additional amount of protection by having the ability to order the immediate liquidation of the account holding the securities and the return of the assets to him. In essence, as the primary beneficiary of the trust, Client insures within the trust agreement that it has the option to put back to the trust (the “put option”) the promissory or trust notes in exchange for the assets deposited with the trust.

Another aspect of embodiment 100, as illustrated in FIG. 1 and alluded to above, is a custodial account created by the entity, designated in FIG. 1 as 4. This relates to the pledge/assignment described immediately above. The assets are deposited to the custodial account by the trustee or other fiduciary and the custodian becomes a signatory to the pledge/assignment agreement by indicating that the agreement is “read and accepted” by the custodian. Therefore, the custodian agrees to liquidate the custodial account and return the assets to Client A, upon Client A's execution of its put option, in this particular embodiment.

In one such embodiment, therefore, the trustee or other fiduciary may open an account for the entity at a financial institution in such a manner that the financial institution may only act as a custodian with respect to the assets, and therefore may only execute a transaction with the assets in the account upon the trustee's or other fiduciary's directions; although, of course, claimed subject matter is not limited in scope in this respect. For example, the custodian could be an entity other than a financial institution, depending on the particular embodiment. It is further noted that while the account in this embodiment is subject to the pledge/assignment agreement, the assets on deposit are fully available to the entity at all times as an asset unless and until a certain triggering event, as specified in the pledge/assignment agreement occurs. Although the trustee or other fiduciary is the sole signatory on the trust or custodial account, nonetheless, the trustee or other fiduciary may have officers with authority to act on behalf of the trustee or other fiduciary.

As indicated previously, the trustee or other fiduciary may issue an entity's promissory or trust note to the order of Client A, designated in FIG. 1 as 5. The note may be made payable at an agreed upon maturity date which could be as short as a day or as long as ten years, or more. The note may be issued pursuant to a non-registered private placement agreement executed by and between sophisticated investors. As previously indicated, in this particular embodiment, the note could be credit enhanced through a pledge of the entity assets. In this embodiment, the face value of the note may correspond to the price expected or desired by Client A for the sale of his securities. In this particular embodiment, the trust note may be issued in advance of closing and may be crafted to become null and void if Client A fails to deliver the asset to the trust or trust-like entity within a pre-agreed upon time.

For this example embodiment, Client A delivers to the account of the trust or trust-like entity, the securities he wishes to sell, designated in FIG. 1 as 6. Depending upon the particular embodiment, the securities may be delivered in a variety of ways and claimed subject matter is not limited in scope to a particular approach. For example, if a financial institution holds the securities to be delivered, the financial institution may arrange to transfer the securities to the benefit of the trust or entity on Euroclear on a “free delivery” basis. Thus, no cash payment is required against the delivery of the securities since Client A received consideration in the form of a trust note of like value. For compliance reasons, however, it may be desirable in some circumstances to have the financial institution of Client A initiate delivery of the securities to the Euroclear or DTC account of the securities firm acting as custodian for the trust or entity, with a notification that the securities are for further credit to the account of the trust for the benefit of the account holder. An advantage of this approach is that compliance responsibility would then remain with the financial institution of Client A. Thus, this approach would further reduce risk to Client A in the event that the transaction was not completed.

In this particular embodiment, it is worth noting that the trustee or other fiduciary for Trust A is the same as for Trust B. Although this provides some advantages, described below, it is noted that claimed subject matter is not limited in scope to this particular arrangement. In an alternate embodiment, the trustees or fiduciaries may be different. Alternatively, it may also be possible to effect an exchange of a security for cash in such a way that the exchange occurs between two different account holders of the same trust structure wherein a single trustee is responsible for internally completing the exchange transactions by swapping cash for a security wherein the trust debit and credits the accounts of the buyer and seller through ledger entries that omits moving assets outside of the trust. However, having the same fiduciary may in a variety of possible situations simplify and expedite exchange transactions while providing additional assurance that an exchange will be properly executed at the desired time with no or virtually no risk that a transaction may fail or be derailed by intermediaries.

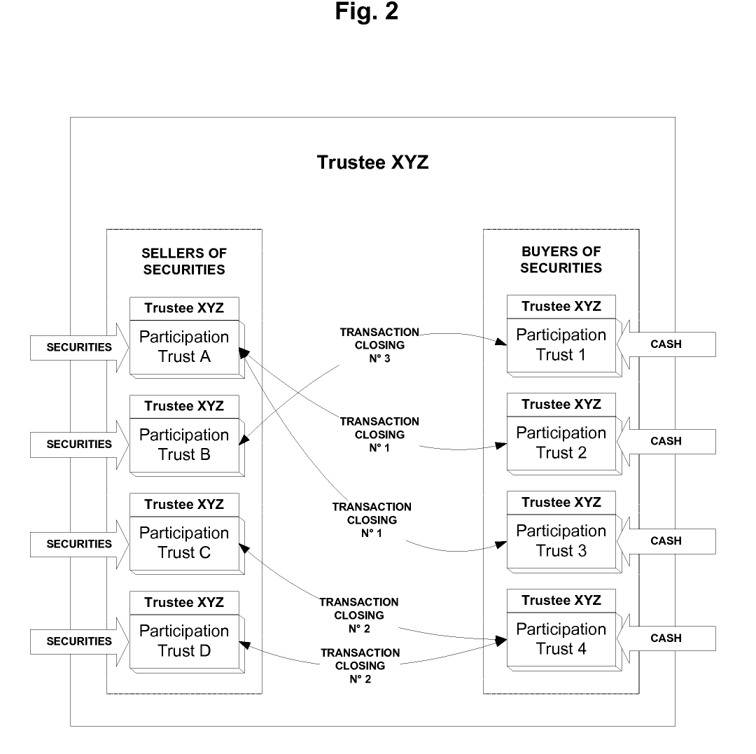

Referring now to the Trust B side of example embodiment 100 shown in FIG. 2, many aspects are similar to those previously described with respect to the Trust A side. However, in this example, Client B is purchasing the securities and is providing funds, in this example cash. Thus, here, cash (in any readily convertible currency, for example) operates as consideration for the issuance by the entity of the promissory or trust note, although, of course, claimed subject matter is not limited in scope in this respect.

If both sides of this example transaction have been mirrored, as described above, the trustee or other fiduciary may issue instructions to the custodian to close the transaction by executing a sale of the securities, designated on the sell side of this transaction by 7 in FIG. 1. Likewise, substantially simultaneously, in this embodiment, the same trustee may issue instructions to the same custodian to close the transaction by executing a purchase of the securities, in exchange for the funds held by Trust B in this example. Therefore, as indicated by 8 in FIG. 1, the custodian transfers cash to the account of Client A, as instructed, and delivers securities to the account of Client B, as instructed.

At this point in the transaction, Clients A and/or B may retain the promissory or trust notes with the assets being held in trust as described above and subject to the previously described pledge. For example, the entity notes may be designed to “revolve” so that more than one transaction closing may be conducted. Likewise, the cash and securities may be employed to facilitate another transaction. If another trust or trust-like entity is set up, such as Trust C, for example, in another embodiment, the entity notes may be exchanged for additional cash or other assets, including, for example, securities, to facilitate more entity note creating transactions. These are merely a few examples of possible post-closing alternatives for this particular embodiment and claimed subject matter is not limited in scope to a particular one. An almost limitless variety of post-closing alternatives are available and it is intended that all fall within the scope of claimed subject matter.

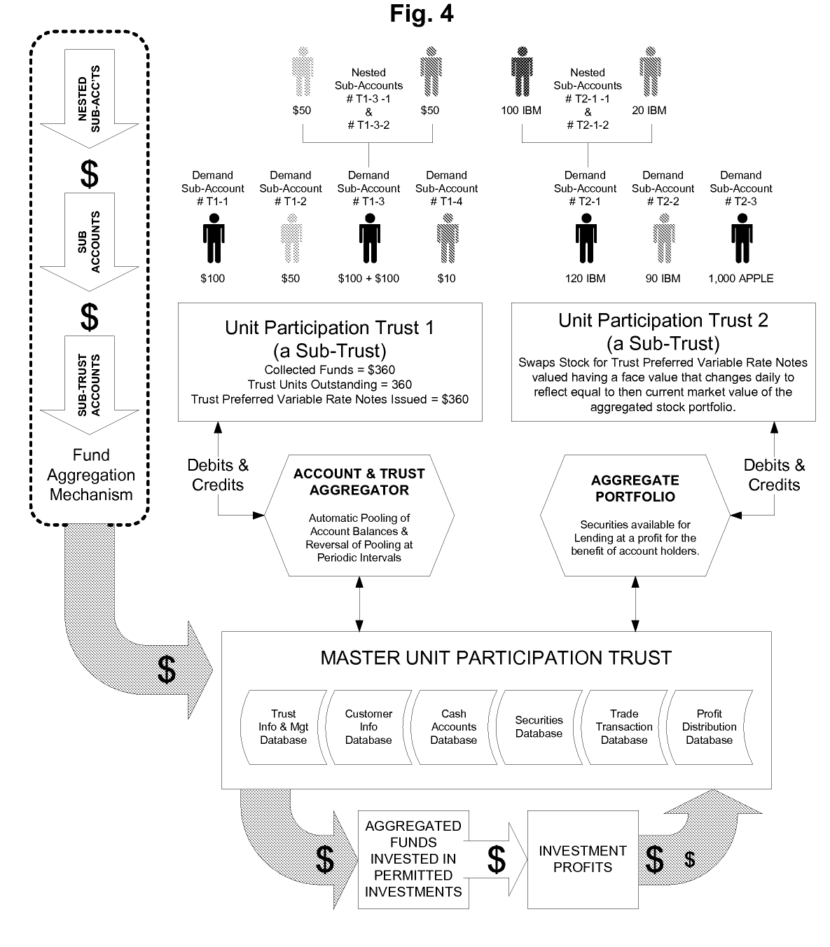

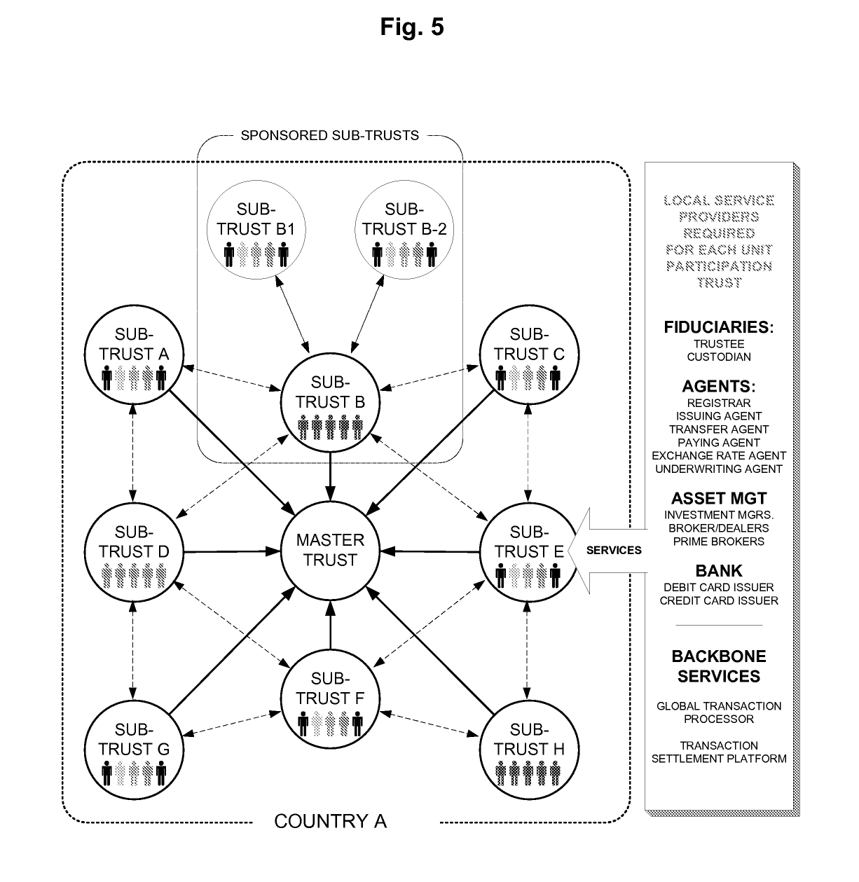

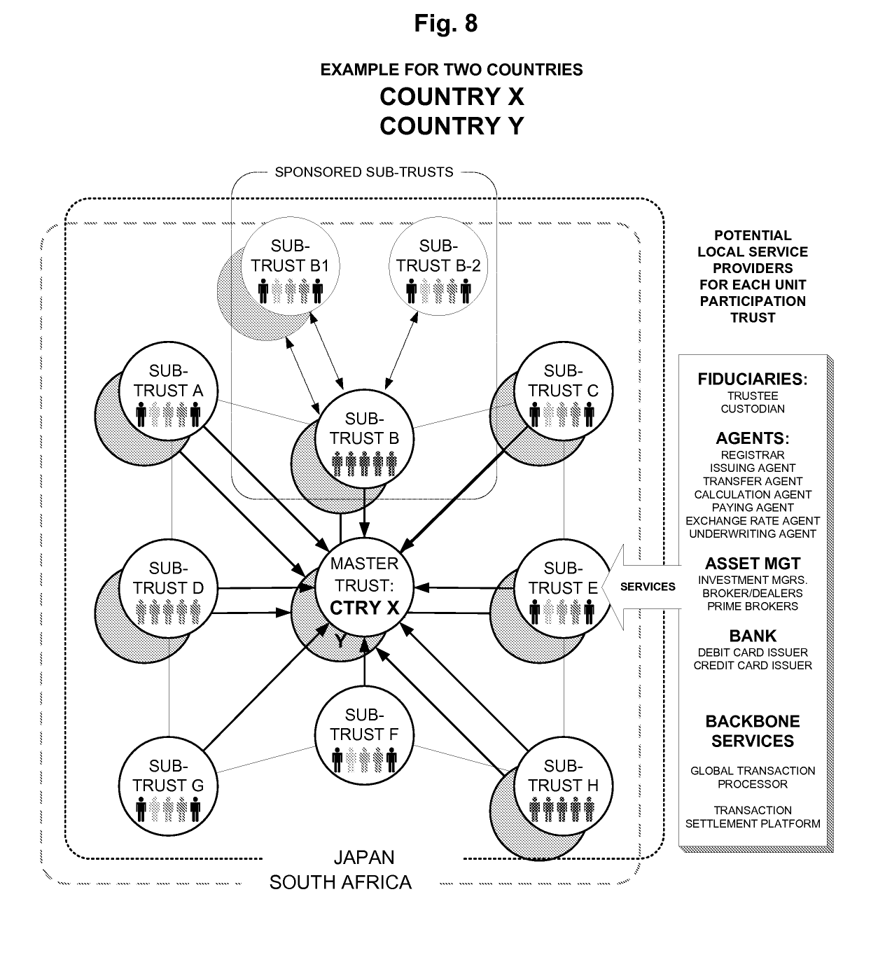

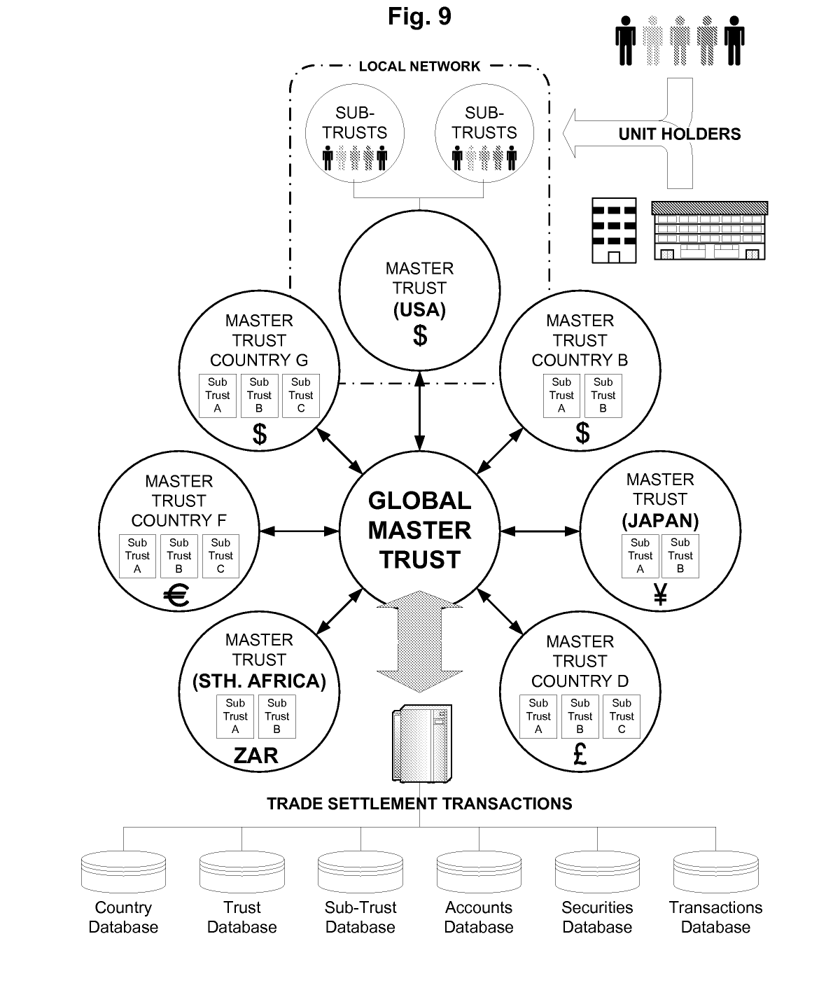

As another alternative, as described in more detail later and in FIGS. 4, 5, 8 and 9, the trusts or trust-like entities may comprise sub-trusts of a master trust that, through a master trust structure, permits Client A and Client B to manage the assets of these sub-trust as desired, such as to engage in exchanges and/or a host of other financial activities, although, again, these are merely examples and claimed subject matter is not limited in scope in this respect.

However, as still another alternative, depending on the particulars, Client A and/or Client B may desire to respectively obtain the cash and securities held in trust or held by a trust-like entity. Therefore, depicted in FIG. 1 as 9 and 10, cash may be provided to Client A and the associated trust or trust-like entity may receive the note and retire the promissory or trust note from its books as a result. A similar process could take place between Client B and Trust B so that Client B may obtain the securities, Trust B may receive the note and the note may be retired from the books of Trust B, as an example.

As noted for the previous embodiment, the same trustee or other fiduciary was employed for Trust A and Trust B. However, again, in alternate embodiments, different fiduciaries or trustees may be employed. In such an embodiment, however, it is beneficial to employ the same custodian to simplify the exchange without concerns regarding compliance or that the terms of the exchange may not be met. If Trust A and Trust B both have the same trustee, or same fiduciary, and the same custodian, there is additional security that an exchange will not begin until assets are available in both Trusts. Therefore, neither side of the transaction incurs significant risk by providing assets in a situation where the transaction may not close. In other words, a potential source of risk may be eliminated or at least greatly reduced by employing the approach associated with this embodiment. Likewise, by taking title to the assets prior to execution of a trade transaction, the trust or trust-like structure provides some additional level of confidence that the assets are real or are accurately described, for example.

FIG. 2 is a schematic diagram illustrating an alternate embodiment 200 of a method of executing a secure exchange transaction between trusts. Again, this is merely another example and claimed subject matter is not limited in scope to this particular embodiment. A host of different types of exchange transactions and arrangements for exchange transactions are possible and are intended to be included with the scope of claimed subject matter.

For embodiment 200, we use an example, for illustration purposes only, of eight trusts or trust-like entities having a common trustee or fiduciary. In this particular embodiment, again, for illustration purposes only, transactions involving an exchange of securities for funds in the form of cash are depicted. However, within the context of claimed subject matter, any type of asset or assets may, of course, be exchanged. In this particular example, three transactions are illustrated as being closed.

This embodiment shares many of the advantages discussed in connection with the previous embodiment and may in some situations provide additional advantages. For this embodiment, it is intended that all the relationships are governed by an agreement that creates a trust or trust-like entity, as previously described. Likewise, as previously discussed, promissory or trust notes are issued providing additional protection.

As noted previously, a desirable feature of this structure is that a transaction may be executed with little effort and with significantly reduced risk of a failed transaction, including various protections to the parties, as previous discussed. These protections include, for example, having the ability to recover the assets by, in essence, “putting” back the notes to the trust (the “put option”) in exchange for the deposited assets under specified conditions, placing potential liability on a trustee (or other fiduciary) or on a custodian should transaction execution procedures not be followed, and having possession of marketable promissory or trust notes to replace the assets provided, etc.

This particular embodiment also illustrates, in one particular aspect, that parties to the transaction may, if desired, remain anonymous. In other words, a trustee and custodian may be employed to handle the mechanics of transaction execution and the identities of the asset owners, parties to the transaction, etc. need not be disclosed to each other. Likewise, a trustee may be engaged whose business extends across multiple borders (e.g., an international bank, for example) so that transactions, global in scope, may be executed as well. Related to this notion, there may be potential benefits associated with the trustee or other fiduciary choosing a closing location that may provide tax advantages for one or more of the parties to the transaction. Likewise, the trustee or other fiduciary, along with the custodian, would in an approach such as that previously described, have legal responsibilities for knowing and insuring compliance with all appropriate rules and regulations that may govern such transactions.

Other features of this approach include the ability to carefully control and time various steps or aspects of the transaction. One feature, for example and without limitation, may be desirable for structured financings, securitization closings, etc. Likewise, intermediaries may find it desirable to employ this transaction approach to bring parties that would otherwise be unaware of the potential exchange/transaction. For example, a transaction may occur without the parties knowing each other or being in contact. In addition to the feature of anonymity, mentioned above, this also may also reduce the chances of inadvertently running afoul of anti-solicitation and/or anti-self dealing rules that may apply to various types of transactions. Likewise, by employing a common trustee or fiduciary, for example, some of the complicated aspects of SWIFT procedures associated with electronic transfer of funds may be avoided. Such procedures could introduce delay and other complications that could negatively affect the closing of a transaction. Therefore, the ability to close complex transactions within the same financial institution, if desired, may greatly reduce the risk of closing delays or of not closing at all.

Another embodiment may include secure transactions execution via the Internet or via another electronic medium. For example, Internet based businesses that bring buyers and sellers together, such as Ebay®, Inc., as merely one example, may be involved in executing transactions. Thus, in one possible embodiment, Ebay could act as a trustee for transactions that take place via its website. Continuing with this example, although, again this is merely for purposes of illustration and is not meant to limit the scope of claimed subject matter, buyers and sellers might first establish accounts with Ebay. Ebay may, for example, employ a master trust agreement under which it may form sub-trusts to hold funds and/or assets for sale. Using a pledge/assignment agreement, Ebay may issue promissory or trust notes to a potential purchaser with a face amount corresponding to the amount of funds deposited or to be deposited by the potential purchaser. Likewise, potential sellers of assets, such as, providing a simple example, sellers of valuable antiques, jewelry, or other valuable properties, for example, may likewise receive promissory or trust notes issued from a sub-trust where the face amount corresponds to the assessed value of the particular asset put in trust. Likewise, Ebay could engage the services of a custodian to take custody of the assets. Thus, in such an embodiment, a buyer or seller providing funds or properties in this manner could feel more comfortable that their funds are only made available if an asset to be purchased is made available for exchange.

As was previously alluded to, the trusts or trust-like entities previously described may comprise sub-trusts of a master trust. Although claimed subject matter is not limited in scope in this respect, one example is provided by subject matter described in U.S. patent application Ser. No. 11/764,175, filed on Jun. 15, 2007 by Alain L. de la Motte, and entitled “Global Fiduciary-Based Financial System for Yield & Interest Rate Arbitrage,” assigned to the assignee of the presently claimed subject matter. Although claimed subject matter is, again, not limited to the subject matter of the foregoing patent application, it does provide a useful example of a system that may benefit from subject of the present application and therefore will be discussed in detail below. Because the approach described employs a master trust structure with a web of sub-trusts in which trust notes are issued in exchange for assets, the subject matter of the present application may provide a useful mechanism to facilitate exchange transactions, as will become more clear from the description below.

Although not so limited, the foregoing application refers at times to a system providing a global trust network or an electronic exchange. As described in the foregoing application, such a system may, for example, use a legal structure for nodes of the master hub comprising of a unit participation trust in which trust beneficiaries are fractional beneficial units owners through acquisition (settled in a particular local currency) of a Trust-Preferred Variable Rate Note which entitles each holder thereof to share in the profits of the trust in pro-rata of his holdings relative to the total assets of the trust. In such an embodiment, such a note may be designed to have a put option which allows the note holder to put the note back to the trust at any time for the purpose of redeeming all of part of his investment in the trust on simple demand. In another embodiment, it can be envisioned that such an option would not exist and that trust deposits would be subject to other conditions.

Therefore, through the use of a trust which is governed both by the trust laws of the country of domicile and by an agreement duly executed between the original grantor (a nominal contributor to start the trust) and a trustee, a system of interrelated trusts may be employed to provide the type of fiduciary protection which the current banking system does not. If a bank becomes insolvent, depositors may loose their entire account balance over and above the insured limit. By contrast a trust can only be managed in accordance with the terms and conditions of the trust agreement and cannot become insolvent if the trust agreement precludes investments that place trust funds at risk. Additionally, since the cash of the trust which is on deposit in the custody of a bank are not considered assets of the bank in the same manner that bank depositors' funds are trust funds placed in the custody of a bank may not under any circumstances be the attached by the creditors of a defaulted or insolvent bank.

In a trust structure envisioned under such an embodiment, a trust may be formed and registered with the local authorities. Formation of the trust may involve the execution of a trust agreement between a grantor (a nominal contributor of cash to form the trust) and a trustee, or in some instances multiple trustees acting as co-trustees. Furthermore, a trust agreement may make provision for the appointment of a variety of services providers to the trust, including, but not limited to: auditors, accountants, tax accountants, legal counsel, global custodians, registrars, issuing agents, transfer agents, calculation agents, paying agents (or paymasters), exchange rate agents, TU Index calculation agents (addressed below), underwriting agents, investment managers, broker/dealers, prime brokers, debit card issuers, credit card issuers, global transaction processors, card transaction settlement platforms, system integrators and managers, and other service providers such as information system integrators and computer services providers, all acting as agents of a trust for the delivery of a service under contract.

In such a system, a trust agreement may govern the management and administration of each trust and permit the periodic aggregation of idle funds on deposit in each account and the investment of the aggregated total in pre-defined investments designed to eliminate or minimize the risk while providing a good return on investment within the guidelines of what the trust agreement calls the “permitted investments” of the trust. In this system, trust note holders may receive periodic dividends on their notes in the form of trust distributions which, to the account holder, represents investment profits.

For such an embodiment, a series of trusts and sub-trusts may be related or connected via a master trust operating at, for example, a country-wide level, although this is mere one example. Likewise, financial transactions may be executed, for example, in such an embodiment, through a transfer of assets upstream from a subsidiary trust, such as a trust or sub-trust, for example, to a parent trust, such as a trust or master trust, or laterally from one trust to another trust, or one sub-trust to another sub-trust, in exchange for a trust preferred variable rate note, giving the subsidiary trust a fractional ownership interest in the master trust. Likewise, multiple country-specific master trusts may be employed, if desired, which, in turn, may be linked upstream to another regional or global trust to form a local, regional or global structure of trusts, which may likewise be inter-related and/or inter-connected, and wherein subsidiary trusts, for example, may with relative ease and freedom buy and/or sell trust-preferred variable rate notes to each other or to the public to move assets or make liquidity adjustments from one trust to another with a modest amount of efforts and/or complications. For instance, a trust based in New York might wire funds at the close of business to a trust based in Hong Kong so that the Hong Kong Trust might be able to trade on the funds of the New York trust during the night and return the funds with profits by the next morning. Additionally, investment opportunities that may exist in one country may be made available to trusts in other countries through simple communication that allows funds to aggregate in the country where funds are able to capture that particular investment opportunity.

Although claimed subject matter is not limited in scope in this respect, in that a Trust Preferred Variable Rate Note issued by one trust to the benefit of another for such an embodiment will govern multiple deposits and withdrawals between the two trusts, the note purchase agreement executed between the two trusts at the onset of a new relationship may make provision for a form of note that has a floating principal balance rather than a fixed note principal amount, wherein the amount due at a particular point in time is the outstanding account balance at that particular time. Therefore, in such an embodiment, for example, a single note purchase agreement executed between two trusts may be employed to govern future debits and credits between the various trusts, for example.

In such an embodiment, for example, the trusts may employ a substantially identical unit participation structure through adoption of a standardized set of trust agreements and master agreements that govern the relationships among the various trust entities (e.g., master trust, trusts, and sub-trusts) including the flow of money from one trust to another and from one country to another. Likewise, although claimed subject matter is not limited in scope in this respect, through a simple process of executing an adoption agreement at the onset, for example, a particular trust node of a national or regional trust network may be able to adopt a body of agreements that may be employed from that point forward to govern the relationship and activities of that trust with the remaining trusts of the network. In this manner, if desired, for example, franchises and/or licenses may be made available for cities, regions, countries and other various sub-divisions. As may be now appreciated, due to a phenomenon sometimes referred to as “network effects,” the more trusts are in operation the more beneficial the entire structure becomes. This is similar to the notion that the more phones around the world, the more beneficial or valuable each phone becomes.

Two additional aspects of such embodiments are worthy of discussion. The first is that if the trust agreements governing the trusts of the network are identical or nearly so, such as with the exception of differing laws and trustees with respect to issues of permitted activities and investments, risks associated with one trust should be nearly identical to another. Therefore the transfer of assets from one to another will not be subjected to any materially greater risk, especially if two trusts have the same trustee, though different rates of return may apply. The second is this, since anyone may be permitted to create a new trust, as an initial grantor, it stands to reason that any individual, company, entity, government of institution may form a trust at least in jurisdictions where trust laws exist and are favorable, that may be connected or otherwise associated with the network through the use of a relatively standardized trust agreement and the adoption of other relevant agreements governing the internal and external relationships of the new trust. Again, claimed subject matter is not limited in scope to such embodiments; nonetheless, as described, these embodiments possess desirable features.

In such an embodiment, trust grantors do not need a banking license per say to start a trust. Of course, trusts typically are subject to special trust laws. In the same way, for example, that banks are require to have a banking license to offer banking products, institutional trustees typically also are licensed to provide trust services. Thus, for an embodiment such as this, a master trust in a particular country or region should satisfy local securities laws and other regulatory issues pertaining to the issuance of securities or loans and the acceptance of trust deposits.

In such embodiment, units holders of a trust will have a trust account designed to have any number of nested sub-accounts that can allow funds to flow upstream from the nested account to the sub-account so that individual units holders of the trust who hold a trust account will be able to host any number of trust accounts under them. In such an embodiment, a nested sub-account comprises a full-fledged trust account. However, in addition it is “nested” underneath a sponsor who holds a primary account. This facility permits, for such an embodiment, a system of account sponsorship to develop, thereby allowing, if desired, networks to form, (e.g. affinity groups, members of a family, members of a church, employees of the same company, etc.) within a trust and for network administrators to allocate or distribute revenue (trust dividends) between the members of a particular network by the network administrator. In another embodiment, it may be possible to have a standardized rate of return administered at the trust level for trust beneficiaries so that relatively equal distribution occurs. In this case, as one example, it is possible to use the services of a paying agent or a paymaster to receive dividends from the trust, and to distribute those funds to the participants of separate networks in accordance with written instructions of the administrator of the particular network based at least in part on an agreement for profit sharing with the members of that network.

In one embodiment, to accomplish its purpose, such a system may use a trust account (or a nested trust account), an escrow account to hold funds for execution of a trade, a trading (also referred to as “trade”) account, a bank account that has a debit card. For such an embodiment, however, a debit card may be linked to the bank account and the trading account may be in turn linked to a yield and interest rate arbitrage trading exchange that will be described further. However, the trust account may further be linked to the trading account, the escrow account and the bank account through a switch so as to pass debits and credits between the trading account, the bank account and the escrow account on the one hand and the trust account on the other hand. In this manner, any funds belonging to a trust beneficiary may be managed at the trust account level, while the trading account, the bank account and the escrow account serve on the front line to meet regulatory banking rules and laws for the issuance of traditional demand deposit bank accounts, trading accounts and escrow accounts.

In such an embodiment, the trust account will typically include multiple sub-trust accounts and sub-trust accounts may be set up to further include any number of nested sub-accounts. The sub-trust accounts and nested sub-accounts, likewise, are respectively linked through the switch to their: (a) corresponding bank account that offers a debit card, (b) trading account linked to an exchange, and (c) an escrow account that receives periodic deposits from the trust account so that performance for the bids submitted by the account holder to the trading exchange platform will take place. Furthermore, one desirable feature associated with this particular approach, the nested sub-accounts and the sub-trust accounts may be set up to be aggregated on a regular basis or at periodic intervals to earn revenue from investing the aggregate amount of funds at the trust level.

In such an embodiment, a switch may be employed that may be implemented in hardware, software, firmware or any combination thereof. In an embodiment that employs the switch, credits and debits directed to the trading account, the escrow account or the bank account are redirected or routed to the trust account. For example, if one were to make a purchase using a debit card, the debit would conventionally be routed to the linked bank account. In such an embodiment, however, a switch reroutes the debit to the trust account and as a result the debit and credit is posted to the account holder's trust account rather than to the bank account which itself may be designed to be a zero-balance, pass-through demand deposit account, in such an embodiment. Similarly, a trade order in which the trading account is to be debited or credited for a particular trade will pass through the switch and be redirected so that a debit or a credit is to be posted to the trust account and to substantially simultaneously post an corresponding debit or credit to the trading account after converting the local currency amount into transaction units, as described below. Of course, again, claimed subject matter is not limited in scope to these embodiments. For example, an alternate embodiment may not employ transaction units.

This may be accomplished, for example, by a mechanism in which, if a debit is incurred, such as via the debit card, for example, the linked accounts may be checked to see which accounts have funds available. In such an embodiment, the bank account may be maintained at a zero balance and therefore the debit may be routed instead to an account with a positive balance, here the corresponding trust account. In the case of a trading account, however, the switch may be designed to route a transaction first to a trading account which may be maintained in a notional index called a transaction units (“TU/s”) in which the balance at a particular point in time represents a notional TU value that is equal or equivalent to the trust account balance at that particular moment in time multiplied by the TU index rate for that particular currency at that particular time. Therefore, as debits and credits are posted through the switch to the corresponding trust account, the balance in TUs in the trading account may be adjusted to reflect an increase or decrease of value in the trust account. Similarly, if a TU denominated settlement request is presented to the switch by the exchange, the switch may first, in such an embodiment, convert the TU amount into the particular local currency of the sub-trust account with the result that a debit or credit may be posted in TU (at the then current exchange rate) to the trading account and substantially simultaneously in local currency to the trust sub-account.

In another embodiment, it is possible to have a system whereby the trust account may also be linked through the switch to a mutual fund account, a savings account, a regular brokerage account, or any other form of financial account or investment account.

In still another embodiment, a debit card may be issued in the name of any non-banking entity. For example, the non-banking entity may comprise at least one of the following: an individual, a non-profit entity; a for-profit entity; or a government entity. For example, a for-profit entity may comprise an employer and the debit card may be issued to an employee of the employer. Likewise, the debit card may be set up to allow the employee to have a nested sub-account of the employee so that he can charge business travel expenses directly to the employer's sub-trust account. In another embodiment, a debit card may be issued in the name of any non-banking entity and co-branded with the name of the bank issuing the debit card. In such an embodiment, therefore, any non-banking entity may take on aspects similar to a bank without incurring the associated regulatory overhead.

It is noted that for such an embodiment, the trust account is set up to allow funds of the trust to be invested in “permitted investments” at least during banking hours. However, the trust account is also set up to allow funds that remain in the trust account outside of normal banking hours to be swept out for short term investment and swept back to the account by the opening of the next banking day for example. It is noted that non-banking hours include evenings, weekends and legal holidays in the particular local or jurisdiction of the trust account during which moneys belonging to the trust can earn interest and profits in the same way that banks currently profit from the use of their customers' aggregated demand deposit account balances.

For such an embodiment to operate effectively, the trading account (TU balance), bank account (pass-through net-zero balance for such an embodiment, for example) and its corresponding debit card, the escrow account and the trust account may be communicatively linked via a system infrastructure. Furthermore, although above we referred to a trust account as being linked to a plurality of accounts, as a practical matter, in actual implementation, in most cases, a user-specific nested sub-account will more likely be set up to post debits and/or credits to the user-specific account, rather than the trust account of the sponsor. More specifically, in such an embodiment, the sub-trust account may be set up to post credits for at least one of the following: cash, cash equivalent marketable instruments, securities, non-liquid assets, or any combination thereof. Likewise, in many instances, credits of cash include regularly recurring deposits, such as payroll check deposits or social security check deposits, to provide only a few examples.

In another embodiment, it may be possible for instance for the owner of equity in a home to transfer the value of that equity to the trust and to receive in exchange a trust-preferred variable rate note of the trust, thereby effectively transferring the ownership of that home equity amount to the trust and receiving credit for it in the form of a trust note. In such an embodiment, therefore, through aggregation upstream of non-cash account balances, as may be permitted by the trust agreement, the trust will be able to aggregate substantial holdings of illiquid assets that can be further pledged or hypothecated so as to receive a master secured loan from a third-party lender wherein the loan proceeds may be posted fractionally to sub-accounts and nested sub-accounts of the trust based on relative contributions to the total trust assets. Whereas the trust will have received a duly executed deed of trust for a variety of real estate properties, it may be possible, in such an embodiment, to further aggregate those assets between trusts through the exchange of notes between trusts and to receive a loan against those assets in which the loan proceeds may flow downward from the master trust to sub-trusts, from sub-trusts to sub-trust account holders and from primary account holders to nested sub-account holders of a network in proportion of respective contributions to the total asset pool. Likewise, in another embodiment, it is possible to create a credit derivative, such as a trust-secured mortgage backed security, with or without a credit enhanced component added to it, wherein these securities are sold into various capital markets to raise longer term liquidity at a potentially lower cost of borrowing. In another embodiment, it is possible to envision specific conditions incorporated in standardized language of a trust agreement to incorporate a put option that may give the holder of a trust-preferred variable rate note an option to sell the note back to the trust thereby placing an obligation on the trust to return the invested illiquid asset to the account holder upon a simple demand that might be made at any time, for example. In this case, the exercise of the put option by the account holder would effectively remove that particular asset from the asset pool of the trust and release the lien the trust has on that asset. In this approach, dormant asset pools may be made to profit through investment of the trusts or through the trading of the fractional loan amount on the trading exchange by the account holder. So long as the cost of borrowing is less than the returns generated from the investment, trust profits can be applied to the reduction of and acceleration of the principal repayment of a first mortgage so as to retire that mortgage earlier than originally planned, thereby potentially saving the account holder interest costs.

In such an embodiment, in which, illiquid assets may be aggregated at the trust level, monetized by tapping into the liquidity markets and invested, such assets, depending at least in part on the embodiment, may comprise any number of different tangible and intangible assets that may take many forms. Examples here have included the consolidation of an aggregated pool of real estate assets (potentially all sorts, e.g. residential, commercial, industrial, etc.) in a trust, however such illiquid asset pooling can take virtually any form, including, but not limited to assets that have an intrinsic and recognized (or appraised) value, such as: intellectual property, patent portfolios, stocks and bonds, mineral deposits in the ground, airplanes, boats, cars, receivables, life insurance policies, annuities, etc.

In the embodiment described above, an advantage of a user-specific sub-trust account includes having the capability to provide for the withdrawal of cash to settle charges resulting from card purchases or for the withdrawal of TU units to settle transactions on the exchange, as was alluded above. More specifically, again, as alluded to previously, for such an embodiment, a bank account may be set up to book a debit from the use of the debit card and to also book an offsetting credit from the corresponding sub-trust account so that the balance in the bank account shows a zero balance, for such an embodiment. Of course, in an alternative embodiment, the bank account might simply maintain a consistent minimum positive balance or merely a consistent balance without loss of generality and the trading account may hold any number of local currencies, instead of transaction units. Likewise, even assuming the balance changes, offsetting adjustments may be made to correctly account for this, if desired. Another advantage of such an embodiment is that a bank account may be further set up to report information regarding debit card usage for a debit card linked to that bank account, which may be convenient at times and provide a way for activity tracking and reporting online or via hard copy bank account statements that show offsetting debits and credits during a specified period of time. Likewise, a bank account may be further set up to report debit card transactions for a debit card linked to that bank account on a regularly recurring basis, such as weekly, monthly, or quarterly, as examples. Also, for such an embodiment, a bank account and a trading account may be further set up to regularly report profits of the corresponding sub-trust account on a recurring basis.

Likewise, in another embodiment, this structure may be implemented through a “nesting” of sub-accounts. In other words, a particular sub-account may operate like a trust account, as just described above, with respect to a group of its own sub-accounts. In this example, the group of sub-accounts may be nested by that particular sub-account. Therefore, the nested sub-trust accounts may be set up to have their funds aggregated on a regular basis to earn revenue at the nesting sub-trust account level from investing the aggregate amount of the funds, in this example embodiment. Therefore, as an example, a debit card corresponding to a particular bank account linked to a nested sub-trust account is able to earn a return from aggregation of funds for investment at the nesting sub-trust level, a desirable feature, particular in comparison with conventional debit cards.

Previously, an embodiment employing a switch was discussed. Although embodiments may be implemented that do not employ a switch, in those embodiments that do, the switch may be conveniently incorporated as a component of the system infrastructure. In such an embodiment, for example, for a debit card purchase transaction, the available balance of the sub-trust account linked to the bank account corresponding to the particular debit card may be accessed and the available balance may be compared with the amount of the debit card purchase transaction. Thus, authentication and acceptance may occur if the available balance is sufficient; however, denial may occur if the available balance is not sufficient in such an embodiment. As will be discussed further with respect to these embodiments, if a trade order is submitted to a trading exchange platform, an amount, in local currency, may be debited from the order giver's account and credited to that account holder's nested escrow account. In such an embodiment, although claimed subject matter is not limited in scope in this respect, an escrow account is set up to block potential withdrawal of funds from an account while a trade order is pending. Thus, while being held in the name of the account holder, in such an embodiment, such escrow deposits permit execution of a trade order by providing a level of assurance of performance by the account holder in the event a trade order which is submitted to the trading exchange platform is accepted. Similarly, presentment of a debit or credit for settlement (in TUs) of a trade that has been executed for an account holder may in such an embodiment be routed first to the suspense escrow account of the account holder so that amounts deposited in the suspense escrow account maybe used to settle a successfully completed trade.

In such an embodiment, a trust account may be linked to a remote trading account in the name of the same account holder that will reside on a trading platform (herein called the “exchange”) so that trading activities of a particular holder may be backed up by a trading account balance which, through the switch, is directly linked to the trust sub-account of the same account holder and the corresponding escrow account that holds cash deposits that back performance on the exchange in the event a posted trade on the exchange platform is accepted. This exchange account may in an embodiment be made remotely accessible to the account holder online, for example, through the Internet, such as through a connection established via phone, or through an electronic device, such as a personal data assistant (PDA) that is programmed and designed to process, transmit or receive information to and from a trading platform of the exchange via wireless connections or through connection to a regular phone line, for example.

As alluded to previously, although claimed subject matter is not limited in scope in this respect, a trading platform (herein referred to as the “exchange”) may likewise be employed. For such an embodiment, trading on the exchange may encompass processing, matching, aggregating and closing bid and ask orders received from holders of trading accounts, even worldwide, for the purpose of creating and closing intra-currency and cross-currency yield and interest rate arbitrage transactions designed to make money with little or no risk for successful bidders of components that make-up the transaction. In such an embodiment, for example the exchange may be operated by a master trust. In such a structure, other trusts, such as those previously described, for example, may report to or have a relationship with the master trust. However, in another embodiment, one may, instead, construct a local infrastructure comprising a local master trust operating its an exchange for the benefit of sub-trusts so as to receive and post offers and bids in a particular local currency, in transaction units or any number other currencies. Likewise, in such an embodiment, a structure may be employed in which exchanges may be operated at various levels, such as operated at a country level or a regional level, and may be connected to a central offer and bid processing system so that offers and bids emanating from a particular country, as one example, may be processed and matched together with offers and bids originating from other exchanges. For such an embodiment, trust account holders may have the ability to post trade orders in their own local currency and in other currencies. It may be possible, therefore, for such an embodiment, to develop an interest rate and yield setting mechanism to determine yields and interest rates for a particular currency of a particular country.

In such an embodiment, if trading account is opened on the exchange, an account holder may adopt, through execution and delivery of a duly notarized or witnessed adoption agreement or other form of signature authentication (including any form of digital signatures), a set of legal documents that will be binding upon the executor and may be employed to govern trading activities of the account holder on the exchange. Such agreements may include, for instance, a master note purchase agreement, a master loan agreement, a global master securities repurchase agreement, a master non-recourse hedge insurance agreement, a master escrow agreement, a master security, pledge and assignment agreement, a master novation agreement, an master option agreement, a master loan repurchase agreement, a master interest rate swap agreement or a master currency swap agreement, etc. wherein the adoption of these agreements by participants on the exchange may be designed to provide a standardized legal framework that not supports the trading activity taking place on the exchange and protects parties and counterparties in a particular trade or loan transaction occurring via the exchange.

Although claimed subject matter is not limited in scope in this respect, the exchange for such an embodiment may be employed to receive process and match two forms of offers or bids: (a) a yield to maturity offer or bid for an investment in a fixed income financial product (bond-like product), or (b) an interest rate offered or bid for a particular loan. Likewise, as is known, yields and interest rates may be converted to specific net revenue numbers through present and future value calculations and/or bond calculation formulas that may be used as an alternate a method of submitting offers and bids. Likewise, although claimed subject matter is not limited in scope in this respect, such offers or bids, for this particular, may be received in a specific target currency and converted into a transaction unit value by the exchange before posting or it, alternatively, it may be received in pre-defined transaction units itself. As discussed previously, although claimed subject matter is not limited in scope in this respect, a transaction unit may be employed that is a notional currency usable on the exchange and based on a proprietary index developed to permit the exchange to function and to receive offers and bids from traders in a variety of currencies. Thus, in such an embodiment, bids may be converted from a local currency to a transaction unit or from a transaction unit into a local currency at the exchange rate of a transaction unit at a particular point in time relative to that particular local currency. The benefits of using a standardized unit of trade will become apparent in the explanations that follow.

For an embodiment such as this, the financial products that will be traded on the exchange are referred to as a “trust-preferred zero coupon note” which is a fixed income investment product or a “trust-secured loan” which is a loan product. It is anticipated that all offers or bids posted on the trading platform of the exchange will be guaranteed by cash deposits (made in local currencies) held in an escrow account or in a segregated and blocked trust account that performs the same basic functions as an escrow account. In order to cause the exchange to accept an offer or a bid, a participant may cause a deposit to be made in escrow through an automatic debit authorization of the bidder's trust account. If the escrow account deposit is made and confirmed by the trust, the exchange may then post the offer or the bid in the trading platform. In the event an offer or a bid is accepted for a trust note the escrow deposit may move to a securitization account so that at all times the trust note will be backed by cash in the local currency backing it. Similarly in the event an offer or a bid is accepted for a secured loan, the escrow deposit may be transferred to the borrower's account and the security pledged as collateral may immediately be transferred to the account of the lender.

In another embodiment it is possible for the trust-preferred zero coupon note to take any number of other forms, including that of a note paying a fixed rate of periodic interest (coupons) which amount may be established through the ask and bid process also, interest-only strips or principal-only strips. Instruments may also take the form of derivatives in which case the value of the primary security is supported by the value of an underlying instrument (e.g. a US Treasury-backed I/O, P/O or an interest earning US Treasury note).

The exchange is intended in an embodiment such as this not only to create and trade cash-backed fixed income instruments of the trust as well as to facilitate the making and securitizing of secured loans, but to also create opportunities for successful bidders to come together through the exchange so as to cooperatively create a series of transactions which at the tail end will result in a profit for all successful bidders through the arbitraging of interest rates and yield to maturity that exist within the offers and bids received either within a single currency or in cross-currency transactions. Trust notes issued through the exchange may be freely transferable and tradable as may the loan portfolios that participants accumulate in their respective accounts.

The adoption of a standardized set of legal agreements by all exchange participants may make it possible for the exchange to use successful offer or bid parameters of an account holder, to calculate and incorporate these parameters in the underwriting of that particular instrument and its subsequent sale via the exchange. For instance the submission of a desired yield to maturity may be converted into a discount or premium price based on the following variables, the date of settlement, the maturity date of the instrument, the coupon rate (if any) expressed in an annual percentage rate of return, the redemption percentage as a percent of the face value of the instrument, the payment dates for coupons (if any)—monthly, quarterly, semi-annually or annually, the number of days in the year. By plugging in the desired yield to maturity in the bond calculation formula, the system may automatically calculate the price of the instrument and the amount of funds to be escrowed as collateral during the life of the product. In the case of a loan, the system may incorporate the parameters of a successful offer or bid interest rate into the loan interest calculation in order to calculate the amount of cash or the value of securities that may to be blocked in escrow to secure the loan. It may further calculate the future value of the interest payment cash flow during the anticipated life of the loan and convert same into a present value at the rate of the most recent yield bid received on the exchange, whereupon it may deduct and set aside a reserved amount (in the currency of the loan) from the trust account of the successful bidder and set aside a sinking funds that may be sufficient to make all interest payments over the life of the loan. It is anticipated that all loan transactions done on the exchange will be fully defeased, principal and interest, wherein the risk of non-payment is reduced or entirely eliminated. Similarly, the pledge of cash to secure a future obligation of a trust note may be reduced or entirely eliminated through the process of setting aside a sufficient amount of cash held in escrow so that the trust can guarantee the obligation.

The purpose of the exchange is to facilitate the coming together of trading partners throughout the world who create, through an offer and bid process, components of a pre-engineered set of nearly simultaneous transactions designed to yield a profitable result achieved through the arbitrage of yield and interest rate differentials that exist around the world both within a single currency (e.g. if a borrower and a lender come together to close a loan instead of each allowing a bank to broker the interest rate between that charged the borrower and that paid the lender to the bank—and in cross-currencies or between countries. In this part of the process which, components of a planned arbitrage may be assembled whereupon a simultaneous escrow-like closing which is designed to close each component of the transaction concurrently and in parallel to each other may be followed by a settlement process. It is noted that the subject matter of the present application regarding executing a secure exchange transaction may therefore be employed.

It will, of course, be understood that, although particular embodiments have just been described, claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that if executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of executing a transaction in which one or more assets, A, is exchanged for one or more assets, B, comprising:
employing at least two trust-like entities to respectively hold the assets;
issuing promissory or trust notes to create liens on the respectively held assets; and
closing the transaction by issuing instructions for the trust-like entities to exchange the assets.

2. The method of claim 1, wherein the at least two trust-like entities comprise at least two trusts.

3. The method of claim 2, and further including retiring the promissory or trust notes.

4. The method of claim 2, wherein the at least two trusts have the same trustee.

5. The method of claim 2, wherein the at least two trusts employ the same custodian for the assets.

6. The method of claim 2, wherein one of A and B comprises securities and the other of A and B comprises funds.

7. The method of claim 2, wherein the assets for the transaction are not located in one country.

8. The method of claim 2, wherein the transaction is facilitated by an online marketplace for exchanging assets.

9. A method of setting up and closing a sale transaction via two trusts having a common trustee comprising:
employing a first and second trust as substantially identical except that a first one holds the assets for sale and a second one holds the funds;
issuing respectively to the provider of the assets and the provider of the funds trust promissory or trust notes in exchange for receiving the assets and funds respectively, with liens placed on the assets and funds as a result; and
closing the transaction by issuing instructions for the assets and funds to be exchanged between the trusts.

10. The method of claim 9, and further comprising: retiring the promissory or trust notes in exchange for receiving the assets from the second trust and the funds from the first trust, respectively.

11. A method of securely closing a transaction comprising:
employing a first trust and second trust so that assets, if delivered to the trusts, respectively become assets of the trust with a first lien on the trust assets, respectively;
issuing trust promissory or trust notes from the first trust and the second trust to the providers of the assets, respectively;
receiving the assets for the first trust and the assets for the second trust; and
issuing instructions to close the transaction by having the first and second trust exchange their respective assets.

12. The method of claim 11, and further comprising: retiring the promissory or trust notes after the transaction has closed by exchanging the first and second trust assets for the promissory or trust notes, respectively.

13. The method of claim 11, wherein the assets comprise securities for sale and funds to purchase the securities, respectively.

14. The method of claim 11, wherein the trustee for the first trust is also the trustee for the second trust.

15. A method comprising:
employing a trust for at least one side of a two-sided transaction, wherein the trust holds assets to be exchanged in the transaction; and
issuing trust promissory or trust notes to the party providing the assets to be exchanged so that a lien is placed on the assets.

16. The method of claim 15, and further comprising:
closing the transaction in response to instructions in which the assets held by the trust are exchanged for other assets.

17. The method of claim 16, wherein the other assets were provided by another trust.

18. The method of claim 17, wherein the trust for at least one-side of a two-sided transaction and the another trust have a common trustee.

19. A system comprising: one or more computing platforms; said computing platforms adapted to execute a transaction in which one or more assets, A, is exchanged for one or more assets, B;
said system operable to: employ at least two trust-like entities to respectively hold the assets, issue promissory or trust notes to create liens on the respectively held assets, and close the transaction by issuing instructions for the trust-like entities to exchange the assets.

20. The system of claim 19, wherein the at least two trust-like entities comprise at least two trusts.

21. The system of claim 20, said system being further operable to retire the promissory or trust notes.

22. The system of claim 20, wherein said system is operable to employ two trusts in which the same trustee is employed.

23. The system of claim 20, wherein said system is operable to employ two trusts in which the same custodian for the assets is employed.

24. The system of claim 20, wherein said system is operable for transactions in which one of A and B comprises securities and the other of A and B comprises funds.

25. The system of claim 20, wherein said system is operable for transactions in which the assets for the transaction are not located in one country.

26. The system of claim 20, wherein said system is operable for transactions facilitated by an online marketplace.

27. A system comprising: one or more computing platforms adapted to execute one or more exchange transactions;
said system operable to: employ a trust for at least one side of a two-sided transaction, wherein the trust holds assets to be exchanged in the transaction, and
issue trust promissory or trust notes to the party providing the assets to be exchanged so that a lien is placed on the assets.

28. The system of claim 27, wherein said system is operable to close the transaction in response to instructions in which the assets held by the trust are exchanged for other assets.

29. The system of claim 28, wherein said system is operable for transactions in which the other assets are provided by another trust.

30. The system of claim 29, wherein said system is operable for transactions in which the trust for at least one-side of a two-sided transaction and in which the another trust have a common trustee.

31. A system comprising: one or more computing platforms; said computing platforms adapted to execute a transaction in which one or more assets, A, is exchanged for one or more assets, B;
said system comprising means for employing at least two trust-like entities to respectively hold the assets, means for issuing promissory or trust notes to create liens on the respectively held assets, and means for closing the transaction by issuing instructions for the trust-like entities to exchange the assets.

32. The system of claim 31, wherein said means for employing at least two trust-like entities comprises means for employing at least two trusts.

33. The system of claim 32, said system further comprising: means for retiring the promissory or trust notes.

34. The system of claim 32, wherein said means for employing at least two trusts comprises means for employing the same trustee.

35. The system of claim 32, wherein said means for employing at least two trusts comprises means for employing the same custodian for the assets.

36. A system comprising: one or more computing platforms adapted to execute one or more exchange transactions;
said system comprising means for employing a trust for at least one side of a two-sided transaction, wherein the trust holds assets to be exchanged in the transaction, and
means for issuing trust promissory or trust notes to the party providing the assets to be exchanged so that a lien is placed on the assets.

37. The system of claim 36, wherein said system further comprises means for closing the transaction in response to instructions in which the assets held by the trust are exchanged for other assets.

38. The system of claim 37, wherein said system further comprises means for executing transactions in which the other assets are provided by another trust.

39. The system of claim 38, wherein said system comprises means for executing transactions in which the trust for at least one-side of a two-sided transaction and in which the another trust have a common trustee.

40. The method of claim 1, wherein said at least two trust-like entities comprise sub-trusts of a single trust, said sub-trusts being organized to hold a particular asset class.

41. The method of claim 40, wherein said sub-trusts comprise a form of trust-owned bankruptcy-remote structures or entities.

42. The method of claim 2, wherein said at least two trusts each have the same beneficiaries.

43. The method of claim 1, wherein the promissory note reflects the indebtedness of the trust-like entity to the note holder while also granting a beneficial ownership interest in the trust-like entity to the note holder corresponding either to the face value of the note or, where the asset held in trust is one or more securities, to the value of the one or more securities based on the daily market value of the one or more securities.

44. The method of claim 1, and further comprising: replacing at least one of the promissory notes by one or more documents reflecting beneficial ownership interest in the corresponding trust-like entity in a particular number of units, where a unit is a standard subdivision of beneficial ownership employed with that corresponding trust-like entity.

45. The method of claim 3, wherein the retirement of at least one of the trust promissory notes occurs at a pre-determined maturity date or earlier through exercise of a put or a call option associated with the at least one trust promissory note.

46. The method of claim 1, wherein at least one of A and B comprises funds and at least the other of A and B comprises one or more securities; and further comprising: settling the exchange transaction after closing; wherein settlement is done in a currency other than the currency of the funds used during the exchange of assets.

47. The method of claim 1, and further comprising: settling the exchange transaction after closing; wherein the settlement of the exchange transaction includes a swap of derivative instruments that derivate their respective values from the A or B assets exchanged.

48. The method of claim 6, wherein said at least two trusts are each arranged to aggregate and invest cash assets of the trust and/or aggregate and lend security portfolios of the trust for profit pending an exchange transaction in which the liquidation of the security or the use of the cash is called for in order to execute the exchange transaction.

49. The method of claim 9, wherein the exchange of assets for a trust promissory note results in a lien being placed on the particular assets exchanged for the particular trust note.

50. The method of claim 11, wherein the trustee for the first trust is not the trustee for the second trust.

51. The method of claim 11, wherein the providers of the assets for the exchange transaction are fractional unit owners of a single trust of which said at least two trusts are sub-trusts; and wherein said exchange transaction is closed within said single trust.

52. The system of claim 20, wherein the providers of the assets for the exchange transaction are fractional unit owners of a single trust of which said at least two trusts are sub-trusts; said system being operable to close said exchange transaction within said single trust.

53. The method of claim 15, wherein said trust is also employed for the other side of the two-sided transaction.

54. The method of claim 53, wherein said trust is employed to hold assets for both sides of the transaction to be exchanged in the transaction; and
wherein said trust issues trust promissory or trust notes to the parties on both sides of the transaction providing the assets to be exchanged so that a lien is placed on the assets.
